(19) United States
(12) Patent Application Publication
(10) Pub. No.: US 2004/0026939 A1
(43) Pub. Date: Feb. 12, 2004

(54) Combination barbecue cooking tool

(76) Inventors: Kenneth Jordan, Columbus, GA (US); Scott Dobias, Columbus, GA (US); Ryan Neal, Midland, GA (US); Richard Harris, Beaver Creek, OH (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/216,586

(22) Filed: Aug. 9, 2002

(51) Int. Cl. A47J 43/28

(52) U.S. Cl. 294/3; 294/7; 294/99.2

(57) ABSTRACT

A combination cooking tool for use when grilling comprises a utensil having a handle with a first and second end, and a tool head extending from the first end of the handle. The utensil is configured to be detachably connected to a second utensil, such that the first utensil and second utensil may be used as a cooking utensil to grasp and manipulate food or other objects.

### TECHNICAL FIELD

The present invention is generally related to cooking tools for use with barbecue grills and more particularly, is related to a combination cooking tool.

### BACKGROUND OF THE INVENTION

Barbecue grills can be used to cook various types of foods, including vegetables and meat, including beef, chicken, fish, pork, etc. A typical barbecue grill comprises a firebox having a cooking surface suspended or supported therein over a source of heat. The cooking surface typically comprises a grate. Cooking generally requires the use of various utensils for handling and cooking the food. While grilling is no exception, grilling commonly uses the same four to six utensils, regardless of whether the grill is being used to cook meats or vegetables.

Grilling is not only as widespread and popular as any other form of cooking, it has become very versatile. Grills can be heated by gas, charcoal, or electricity and can be used indoors or outdoors. Regardless of how or where the food is grilled, the selected heat source for the grill, or with which heat source the user grills, more than likely the user will need a plurality of utensils to handle and cook the food and to care for the grill. These utensils can include, for example, a spatula to flip or turn the food product; tongs to handle the food, such as for removal or placement of the food products onto the grill; a fork for manipulating the food product; a brush for brushing on barbecue sauce, or the like; and a scraper or brush for cleaning residue off the grill before and after cooking. It is desirable that the tools used while grilling include a somewhat elongated handle such that the user can keep a reasonable distance from the heat while working with the food or cleaning the cooking surface. These tools are awkward and space consuming to store and transport. As such, grilling requires the care, maintenance and keeping track of a variety of tools and utensils that are usually relatively large and unwieldy, and it is desirable to use, maintain, and transport as few tools as possible when using a barbecue grill.

Thus, a heretofore unaddressed need exists in the industry to address the aforementioned deficiencies and inadequacies.

### SUMMARY OF THE INVENTION

Preferred embodiments of the present invention provide a combination cooking tool apparatus for use when grilling. Briefly described, in architecture, one embodiment of the apparatus can be implemented as follows. A combination cooking tool for use when grilling comprises a utensil having a handle with a first and second end, and a tool head extending from the first end of the handle. The utensil is configured to be detachably connected to a second utensil, such that the first utensil and second utensil may be used as a cooking utensil to grasp and manipulate food or other objects.

Other systems, method, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 illustrates a top view of one exemplary embodiment of a cooking utensil of an embodiment of the combination cooking tool of the present invention.

FIG. 2 is a front view of a preferred embodiment of the cooking tool head of the exemplary cooking utensil illustrated in FIG. 1.

FIG. 3 is a side view of one embodiment of a connecting piece of the exemplary cooking utensil illustrated in FIG. 1.

FIG. 4 is a top view of an exemplary second cooking utensil of and embodiment of the combination cooking tool of the present invention.

FIG. 5 is a side view of a preferred embodiment of the cooking tool head of the exemplary cooking utensil of FIG. 4.

FIG. 6 is a side view of an embodiment of the combination cooking tool of the present invention implementing the exemplary cooking utensil of FIG. 1 and the exemplary second cooking utensil of FIG. 4.

### DETAILED DESCRIPTION OF THE PREFERRED EMBODIMENTS

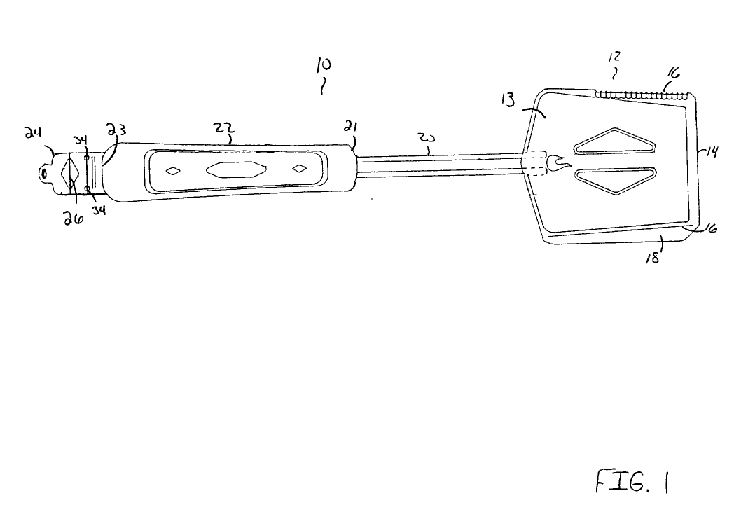

FIG. 1 illustrates one implementation of a cooking utensil 10 of an embodiment of the combination cooking tool 80 (FIG. 6) of the present invention. The preferred cooking utensil 10 generally comprises a handle 22 having a tool head 12 extending therefrom. The preferred handle 22 is substantially elongated and defined by a first end 21 and second end 23. The handle 22 is substantially arcuate in shape and preferably comprises a substantially rigid material, such as a hard plastic, hard rubber, or any suitable material. In some embodiments, the first end 21 of the handle 22 will directly attach to the tool head 12. In other embodiments, as illustrated in FIG. 1, the handle 22 may be separated from the tool head 12 by a throat portion 20. The preferred throat portion 20 is preferably a substantially rigid material, such as a hard plastic, hard rubber, metal, or any suitable material. Additionally, the throat portion 20 may be constructed of the same material as the handle 22, but is not required to be the same material.

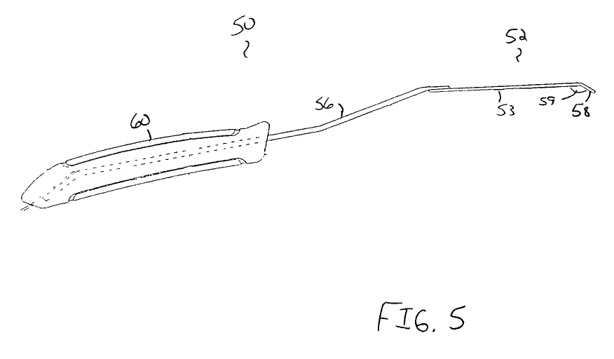

The preferred tool head 12 is disposed toward the first end 21 of the handle 22. The tool head 12 may be of a variety of shapes in various embodiments, including a spatula (FIG. 1), or a fork (see FIG. 4), or other appropriate shapes. FIG. 1 illustrates one embodiment implementing a spatula. In the preferred embodiment of the spatula illustrated in FIG. 1, the tool head 12 is substantially rectangular in shape and defined by an upper surface 13 and a lower surface (not shown). It should be understood that although the tool head 12 is illustrated as being substantially rectangular, the tool head 12 can comprise any suitable shape.

As illustrated in FIG. 1, in one embodiment, the substantially rectangular tool head 12, can include a front edge 14 and side edges 16. In the preferred embodiment shown in FIG. 1, the tool head 12 will include at least one side edge 16 with a raised portion 18. The preferred raised portion 18 of the embodiment of the spatula shown in FIG. 1 extends upwardly from the upper surface 13 of the tool head 12. As would be known to one of ordinary skill in the art, the raised portion 18 assists the user of the cooking utensil 10 when the spatula cooking utensil 10 is being used to flip or turn food items, by providing greater control over the food item being turned or flipped.

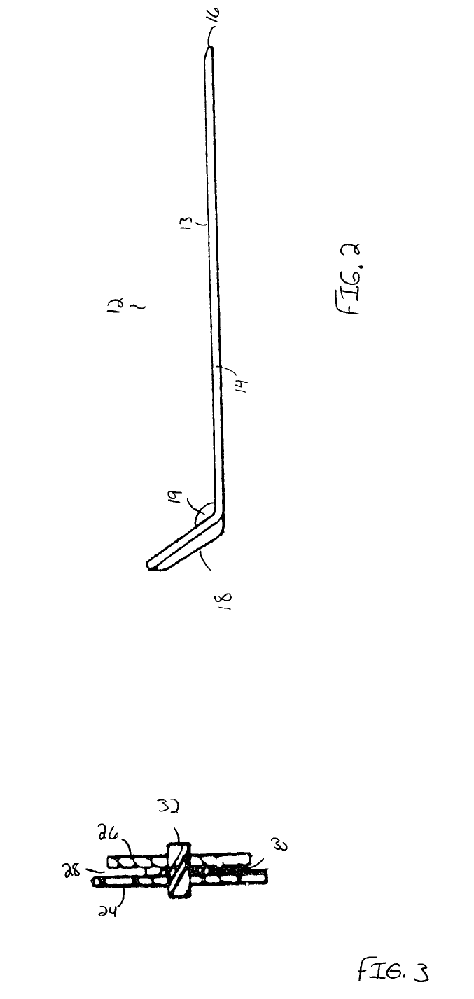

FIG. 2 further illustrates a preferred implementation of the raised portion 18. As depicted in FIG. 2, the raised portion 18 extends upwardly from the upper surface 13 of the tool head 12. In the preferred embodiment illustrated in FIG. 2, there is only one raised portion 18 extending upwardly from the upper surface 13 at one of the side edges 16. In other embodiments, there may be more than one raised portion 18, each extending upwardly from the upper surface 13 from a different side edge 16, or extending upwardly from the tool head 12 at other locations.

Further, as shown in FIG. 2, the raised portion 18 may extend upwardly from the upper surface 13 of the tool head 12 at an angle 19 with respect to the upper surface 13. In the preferred embodiment, the angle 19 between the upper surface 13 and the raised portion 18 will be in the approximate range of between 90° and 180°.

Returning to FIG. 1, in the preferred embodiment, the cooking utensil 10 will be configured to be detachably connected to a second cooking utensil 50 (FIG. 4) to form an embodiment of the combination cooking tool 80 (FIG. 6). As would be known to one of ordinary skill in the art, there are various ways the detachable connection may be implemented, and all such implementations are intended to be within the scope of the present invention. One preferred embodiment of a detachable connection will be described below with respect to FIGS. 1, 4, and 6. This preferred embodiment is in no way intended to limit the scope of the present invention, and is merely presented as an illustration of one implementation of the detachable connection.

In the preferred embodiment illustrated in FIG. 1, a flexible connector 24 with a top surface 25 and a bottom surface (not shown) is attached to the second end 23 of the handle 22. The flexible connector 24 may be securely attached to the handle 22 in a variety of ways, as would be known to one of ordinary skill in the art. Additionally, the preferred flexible connector 24 will be somewhat more malleable than the handle 22, allowing the flexible connector 24 to bend when pressure is applied to the flexible connector 24, but also returning the flexible connector 24 to its original shape when the pressure is removed. As would be known to one of ordinary skill in the art, the flexible connector 24 may be made of a variety of materials, including plastic, rubber, metal, etc., with the degree of malleability varying with the material selected, thickness of the flexible connector 24, etc.

The preferred flexible connector 24 illustrated in FIG. 1, extends outwardly from the second end 23 of the handle 22. The preferred flexible connector 24 includes a curved portion 36 (FIG. 6) and a flat portion 38 (FIG. 6). In the preferred embodiment, the curved portion 36 (FIG. 6) of the flexible connector 24 is attached to handle 22 of the cooking utensil 10, and the flat portion 38 (FIG. 6) extends outwardly from the curved potion 36 (FIG. 6) at the end of the curved portion 36 (FIG. 6) opposite the handle 22.

The preferred flexible connector 24 also includes a raised connecting piece 26 attached to the top surface 25 of the flat portion 38 (FIG. 6) of the flexible connector 24. As discussed below, the raised connecting piece 26 is one preferred way to detachably connect the cooking utensil 10 to a second cooking utensil 50 (FIG. 4) to form the combination grill tool 80 (FIG. 6). As illustrated in FIG. 1, the raised connecting piece 26 may be diamond shaped. In other embodiments, the raised connecting piece 26 may be any of a variety of shapes, including square, rectangular, oval, triangular, polygonal, etc.

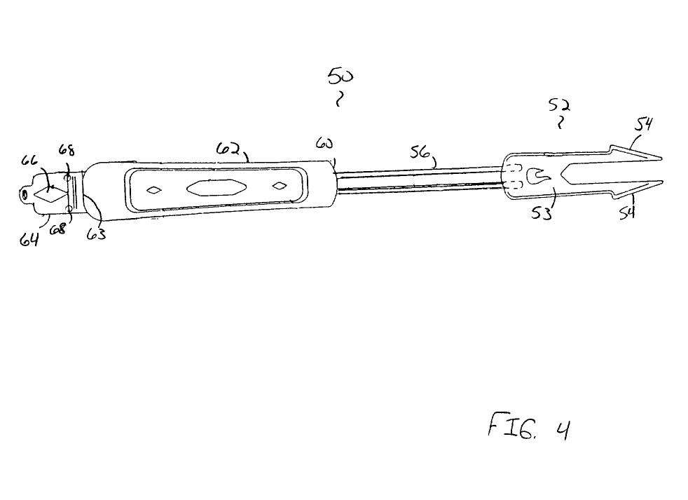

In a preferred embodiment illustrated in FIG. 3, the raised connecting piece 26 is attached to the flexible connector 24 such that a gap 28 is formed between the raised connecting piece 26 and the top surface 25 of the flexible connector 24. In the preferred embodiment depicted in FIG. 3, the raised connecting piece 26 may be attached to the flexible connector 24 with a pin 32 disposed through the raised connecting piece 26 and the flexible connector 24. As would be known to one of ordinary skill in the art, other methods of attaching the raised connector piece 26 to the flexible connector 24 such that the gap 28 is formed are possible, and all such methods are intended to be within the scope of the preferred embodiment of the present invention.

Further, in the preferred embodiment depicted in FIG. 3, a spacer 30 may be provided between a portion of the raised connector piece 26 and the upper surface 25 of the flexible connector 24. The preferred spacer 30 may, among other things, ensure that the gap 28 is substantially maintained between the raised connecting piece 26 and the upper surface 25 of the flexible connector 24 during the use of the cooking utensil 10.

Returning to FIG. 1, in the preferred embodiment, the cooking utensil 10 will optionally include a method or mechanism for releasably locking the cooking utensil 10 and the second cooking utensil 50 (FIG. 4) once they are connected. As would be known to one of ordinary skill in the art, there are various methods and mechanism for releasably locking the cooking utensil 10 to the second cooking utensil 10, 50 (FIG. 4). For instance, in various embodiments, locking mechanisms such as latches, pins, clips, etc. may be used. In the preferred embodiment, the flexible connector 24 illustrated in FIG. 1 also optionally includes at least one locking mound 34 extending upwardly from the top surface 25 of the flat portion 38 (FIG. 6) of the flexible connector 24.

As described below, the locking mound(s) 34 assist in releasably locking the cooking utensil 10 into place with a second cooking utensil 50 (FIG. 4) to form an implementation of the combination cooking tool 80 (FIG. 6). In the preferred embodiment illustrated in FIG. 1, two locking mounds 34 are implemented. In other embodiments, more or fewer locking mounds 34 may be implemented in varying configurations on the flat portion 38 (FIG. 6) of the flexible connector 24.

FIG. 4 illustrates an embodiment of a second cooking utensil 50 of a preferred embodiment of the combination grill tool 80 (FIG. 6) of the present invention. The preferred second cooking utensil 50 may be similar in some respects to the cooking utensil 10 illustrated in FIG. 1. Further, the second cooking utensil 50 and cooking utensil 10 may be the same type, i.e. spatula, fork, etc., or may be different types.

As with the embodiment of the cooking utensil 10 illustrated in FIG. 1, the preferred second cooking utensil 50 generally comprises a handle 62 having a tool head 52 extending therefrom. The preferred handle 62 is substantially elongated and defined by a first end 61 and second end 63. The preferred handle 62 is substantially arcuate in shape and preferably comprises a substantially rigid material, such as a hard plastic, hard rubber, or any suitable material. In some embodiments, the first end 61 of the handle 62 will directly attach to the tool head 52. In other embodiments, as illustrated in FIG. 4, the handle 62 may be separated from the tool head 52 by a throat portion 56. The throat portion 56 is preferably a substantially rigid material, such as a hard plastic, hard rubber, metal, or any suitable material. Additionally, the throat portion 56 may be constructed of the same material as the handle 62, but is not required to be the same material.

The tool head 52 of the second cooking utensil 50 is disposed toward the first end 61 of the handle 62. The preferred tool head 52 has an upper surface 53 and a lower surface (not shown) and may be of a variety of shapes in various embodiments, including a spatula (FIG. 1), or a fork (FIG. 4), or other appropriate shapes. FIG. 4 illustrates one embodiment implementing a fork tool head 52. As depicted in FIG. 4, the fork tool head 52 is provided with a plurality of tines 54. In the embodiment depicted in FIG. 4, two tines 54 are implemented, however, in other embodiments, additional tines 54 may be implemented in the fork tool head 52.

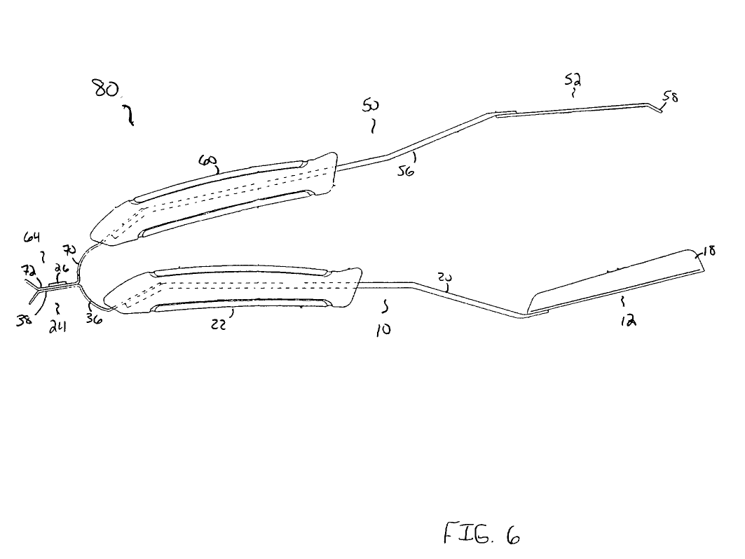

FIG. 5 illustrates further details of a preferred embodiment of the fork tool head 52. In the preferred embodiment shown in FIG. 5, the tines 54 include raised tips 58 extending upwardly from the upper surface 53 of the tool head 52 at an angle 59 relative to the upper surface 53. The raised tips 58 extend upwardly from the end of the tool head 52 opposite the end of the tool head 52 connected to the throat 56 (FIG. 4). As would be known to one of ordinary skill in the art, the raised tips 58 assist the user of the cooking utensil 50 when the user manipulates food with the tines 54 of the tool head 52. Additionally, in the preferred embodiment depicted in FIG. 5, the raised tips 58 extend upwardly from the upper surface 53 of the tool head 52 at an angle 59 that is between the approximate range of 90° and 180° with respect to the upper surface 53 of the tool head 52.

Returning to FIG. 4, in the preferred embodiment, the second cooking utensil 50 will be configured to detachably connect to the cooking utensil 10 to form an embodiment of the combination cooking tool 80 (FIG. 6). In the embodiment illustrated in FIG. 4, a second flexible connector 64 with a top surface 65 and a bottom surface (not shown) is attached to the second end 63 of the handle 62. The second flexible connector 64 may be securely attached to the handle 62 in a variety of ways, as would be known to one of ordinary skill in the art. Additionally, the preferred second flexible connector 64 will be somewhat more malleable than the handle 62, allowing the second flexible connector 64 to bend when pressure is applied to the second flexible connector 64, but also returning the second flexible connector 64 to its original shape when the pressure is removed. As would be known to one of ordinary skill in the art, the second flexible connector 64 may be made of a variety of materials, including plastic, rubber, metal, etc., with the degree of malleability varying with the material selected, thickness of the second flexible connector 64, etc.

The preferred second flexible connector 64 illustrated in FIG. 4 extends outwardly from the second end 63 of the handle 62. The preferred second flexible connector 64 includes a curved portion 70 (FIG. 6) and a flat portion 72 (FIG. 6). In the preferred embodiment, the curved portion 70 (FIG. 6) of the second flexible connector 64 is attached to handle 62 of the second cooking utensil 50, and the flat portion 72 (FIG. 6) extends outwardly from the curved potion 70 (FIG. 6) at the end of the curved portion 70 (FIG. 6) opposite the handle 62.

In the preferred embodiment, the second flexible connector 64 also includes a connecting aperture 66 disposed through the flat portion 72 (FIG. 6) of the second flexible connector 64. As discussed below, the preferred connecting aperture 66 is configured to receive the preferred raised connecting piece 26 (FIG. 1) of the cooking utensil 10, providing an implementation of the detachable connection between the second cooking utensil 50 and the cooking utensil 10 (FIG. 1) to form an embodiment of the combination cooking tool 80 (FIG. 6).

As discussed above with respect to FIG. 1, the preferred raised connecting piece 26 is substantially diamond shaped. In other embodiments, the preferred raised connecting piece 26 may be any of a variety of shapes, including square, rectangular, oval, triangular, polygonal, etc. Similarly, the preferred connecting aperture 66 of the second flexible connector 64 illustrated in FIG. 4 may also be diamond shaped, square, rectangular, oval, triangular, polygonal, etc., depending on, and substantially corresponding to the implemented shape of the raised connecting piece 26.

Returning to FIG. 4, in the preferred embodiment, the second cooking utensil 50 will optionally include a method or mechanism for releasably locking the second cooking utensil 50 and the cooking utensil 10 (FIG. 1) once they are connected. As would be known to one of ordinary skill in the art, there are various methods and mechanisms for releasably locking the second cooking utensil 50 to the cooking utensil 10 (FIG. 1). For instance, in various embodiments, locking mechanisms such as latches, pins, clips, etc. may be used. FIG. 4 illustrates one preferred implementation of the releasable locking mechanism.

As illustrated in FIG. 4, the preferred second flexible connector 64 further includes at least one locking aperture 68 disposed into the top surface 65 of the flat portion 72 (FIG. 6) of the second flexible connector 64. As described below, the locking aperture(s) 68 are configured to receive the locking mound(s) 34 (FIG. 1) to assist in releasably locking the second cooking utensil 50 into place with the cooking utensil 10 (FIG. 1). In the embodiment shown in FIG. 4, two locking apertures 68 are implemented. In other embodiments, more or fewer locking apertures 68 may be implemented in varying configurations on the flat portion 72 (FIG. 6) of the second flexible connector 64.

FIG. 6 illustrates one embodiment of the combination cooking tool 80 of the present invention. As shown in FIG. 6, an embodiment of the cooking utensil 10 is detachably connected to an embodiment of the second cooking utensil 50 to form an embodiment of the combination cooking tool 80 capable of manipulating food. In this manner, the embodiment of the combination cooking tool 80 shown in FIG. 6, allows manipulation of the food or other objects in a manner that may not be accomplished through use of either the cooking utensil 10 or second cooking utensil 50 separately.

In the preferred embodiment depicted in FIG. 6, the raised connecting piece 26 of the flexible connector 24 of the cooking utensil 10 is disposed through the connecting aperture 66 (not shown in FIG. 6) of the second flexible connector 64 of the second cooking utensil 50, detachably connecting the cooking utensil 10 and second cooking utensil 50. Further, as illustrated in FIG. 6, the locking mounds 34 of the flexible connector 24 of the cooking utensil 10 are seated in the locking apertures 68 (not shown in FIG. 6) of the second flexible connector 64 of the second cooking utensil 50, releasably locking the cooking utensil 10 and second cooking utensil 50 into the configuration depicted in FIG. 6. As discussed above, this illustrates one implementation of the detachable connection and releasable locking mechanism.

In the preferred embodiment illustrated in FIGS. 1, 4, and 6, the cooking utensil 10 and second cooking utensil 50 may be detachably connected by rotating either cooking utensil 10 or second cooking utensil 50 with respect to the other to align the raised connecting piece 26 with the connecting aperture 66. The raised connecting piece 26 is then inserted into the connecting aperture 66. In the preferred embodiment, the cooking utensil 10 and second cooking utensil 50 are detachably connected by rotating either cooking utensil 10 or second cooking utensil 50 ninety degrees with respect to the other to align the raised connecting piece 26 with the connecting aperture 66. However, in other embodiments, a lesser or greater degree of rotation may be implemented.

Either cooking utensil 10 or second cooking utensil 50 may then be rotated until the cooking utensil 10 and second cooking utensil 50 are substantially in the same plane as illustrated in FIG. 6. The cooking utensil 10 and second cooking utensil 50 may be releasably locked into that position by seating the locking mound(s) 34 into the locking aperture(s) 66. These steps may be reversed to detach the cooking utensil 10 from the second cooking utensil 50 to allow separate use of cooking utensil 10 and/or second cooking utensil 50.

When connected in the preferred embodiment illustrated in FIG. 6, the preferred flexible connector 24 of cooking utensil 10, and the preferred second flexible connector 64 of cooking utensil 50, serve to provide a fulcrum. This fulcrum allows this embodiment of the combination cooking tool 80 to be used in the manner of tongs, wherein a user may grasp handle 22 and handle 62 in one hand, and by applying pressure to handle 22 and handle 62, grasp and/or manipulate food or other objects between the tool head 12 of the cooking utensil 10 and the second tool head 52 of the second cooking utensil 50.

When such pressure is applied to handle 22 and handle 62, the configuration of the preferred embodiment of the flexible connector 24 and second flexible connector 64 operates to apply a separating force between the flat portion 38 of the flexible connector 24 and the flat portion 72 of the second flexible connector 64. This separating force in turn applies pressure between the portion of the raised connecting piece 26 overlapping the flat portion 72 of the second flexible connector, serving to further secure the detachable connection when the preferred combination cooking tool 80 is used to grasp objects as described above.

Further, as discussed above, the preferred flexible connector 24 and preferred second flexible connector 64 are configured to provide resistance when the user manipulates the preferred combination cooking tool 80 is used to grasp objects as described above. The resistance provided by the preferred flexible connector 24 and second flexible connector 64 serves to separate the tool head 12 of the cooking utensil 10 and the second tool head 52 of the second cooking utensil 50 when the user ceases applying pressure to handle 22 and handle 60.

In this manner, in the preferred embodiment, the user may use the spatula cooking utensil 10 and/or fork cooking utensil 50 separately for some uses, and then when desired, may detachably connect the two cooking utensils 10, 50 to form a third combination cooking tool 80 performing functions not readily available by use of the cooking utensils 10, 50 separately.

The embodiment depicted in FIGS. 1-6 illustrate one preferred embodiment of the combination cooking tool 80 of the present invention. Other embodiments would be known to one of ordinary skill in the art and are intended to be within the scope of the present invention. For example, in alternative embodiments, both cooking utensils 10, 50 may be spatula-type utensils. In other embodiments, both cooking utensils 10, 50 may be spatula-type utensils. In yet other embodiments, one or both of the cooking utensils 10, 50 may be other types of utensils capable of being combined to operate together as described above, as would be known to one of ordinary skill in the art.

Similarly, other ways and methods of detachably connecting two cooking utensils 10, 50 may be implemented in alternative embodiments of the present invention. By way of example, the detachable connection could be performed by a spring-type hinge configured to be connected to the cooking utensils 10, 50, as well as by a pin connecting the second end 23 of the handle 22 of the cooking utensil 10 to the second end 63 of the handle 62 of the second cooking utensil 50.

Accordingly, it should be emphasized that the above-described embodiments of the present invention, particularly, any “preferred” embodiments, are possible examples of implementations, merely set forth for a clear understanding of the principles of the present invention. Many variations and modifications may be made to the above-described embodiments(s) of the invention without department substantially from the spirit and principles of the invention. All such modifications and variations are intended to be included herein within the scope of this disclosure and the present invention and protected by the following claims.

Therefore, having thus described the invention, at least the following is claimed:

1. A combination cooking tool apparatus, comprising:
a first utensil, said first utensil comprising:
a handle having a first end and a second end;
a tool head having an upper surface and a lower surface, said tool head extending from the first end of said handle;
a second utensil, said second utensil comprising:
a handle having a first end and a second end;
a tool head having an upper surface and a lower surface, said tool head extending from the first end of said handle; and
a detachable connection between the first utensil and the second utensil, such that when the first utensil is detachably connected to the second utensil, the tool head of the first utensil and the tool head of the second utensil may be operated to grasp or manipulate objects.

2. The combination cooking tool apparatus of claim 1, wherein the detachable connection provides resistance when a user moves the handle of the first utensil and the handle of the second utensil towards each other.

3. The combination cooking tool apparatus of claim 2, wherein the detachable connection further comprises:
a first flexible connector attached to the second end of the handle of the first utensil; and
a second flexible connector attached to the second end of the handle of the second utensil.

4. The combination cooking tool apparatus of claim 3, wherein the detachable connection further comprises:
a raised connecting piece attached to the top surface of the first flexible connector; and
a connecting aperture disposed through the second flexible connector;
wherein the raised connecting piece of the first flexible connector and connecting aperture of the second flexible connector are configured such that the raised connecting piece may be removably secured into the shaped aperture.

5. The combination cooking tool apparatus of claim 4, wherein the first flexible connector further comprises a spacer disposed between a portion of the raised connecting piece and the top surface of the first flexible connector.

6 The combination cooking tool apparatus of claim 4, wherein the first utensil is detachably connected to the second utensil by fitting the raised connecting piece of the first utensil into connecting aperture of the second utensil connector, and rotating either the first utensil or the second utensil until the first utensil and the second utensil are substantially in the same plane.

7. The combination cooking tool of claim 6, further comprising means to releasably lock the first utensil and the second utensil together in substantially the same plane.

8. The combination cooking tool apparatus of claim 7, wherein the means to releasably lock further comprises:
at least one locking mound extending upwardly from the surface of the first flexible connector; and
as least one locking aperture disposed into the surface of the second flexible connector;
wherein each locking mound of the first flexible connector is configured to seat into a corresponding locking aperture of the second flexible connector.

9. A cooking tool comprising:
a cooking utensil, the cooking utensil comprising:
a handle having a first end and a second end;
a head having an upper surface and a lower surface, said head extending from the first end of said handle;
wherein the cooking utensil is configured to be used alone and is further configured to be detachably connectable to a second utensil to form cooking tongs.

10. The cooking tool of claim 9, wherein the cooking utensil further comprises a flexible connector affixed to the second end of the handle, the flexible connector configured to be detachably connected to a second flexible connector affixed to a second utensil.

11. The cooking tool of claim 9, wherein the head of the cooking utensil is configured with a front edge and a plurality of side edges; and wherein at least one of the plurality of side edges is configured with a raised portion extending upwardly from the upper surface of the head of the cooking utensil.

12. The cooking tool of claim 11, wherein the raised portion extends upwardly from the upper surface of the head of the cooking utensil at an angle of ninety degrees or greater relative to the upper surface of the head of the cooking utensil.

13. The cooking tool of claim 9, wherein the head of the cooking utensil is configured with a plurality of tines, the plurality of tines further including end portions extending upwardly from the upper surface of the head of the cooking utensil.

14. The cooking tool of claim 13, wherein the end portions extend upwardly from the upper surface of the head of the cooking utensil at an angle of ninety degrees or more relative to the upper surface of the head of the cooking utensil.
